(19) United States
(12) Patent Application Publication
(10) Pub. No.: US 2005/0186481 A1
(43) Pub. Date: Aug. 25, 2005

(54) Lithium-ion secondary battery

(75) Inventors: Kazuya Ogawa, Chuo-ku (JP); Atsushi Sano, Chuo-ku (JP); Tsuyoshi Iijima, Chuo-ku (JP); Keiko Inoue, Chuo-ku (JP); Satoshi Maruyama, Chuo-ku (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 10/990,529

(22) Filed: Nov. 18, 2004

(30) Foreign Application Priority Data
Nov. 20, 2003 (JP) 2003-391198

(51) Int. Cl. H01M 10/40

(52) U.S. Cl. 429/332; 429/331; 429/340

(57) ABSTRACT

A lithium-ion secondary battery 1 comprises an anode including a conductive anode active material containing layer containing an anode active material; a cathode including a conductive cathode active material containing layer containing a cathode active material; a nonaqueous electrolytic solution containing a lithium salt, propylene carbonate, and a linear carbonate; and a case accommodating the anode, cathode, and nonaqueous electrolytic solution in a closed state. The nonaqueous electrolytic solution further contains an additive satisfying the condition represented by expression (1): +0.9V≦(E2−E1)≦+2.5V, whereas the moisture content in the anode active material containing layer is regulated so as to satisfy the condition represented by expression (2): 40 ppm≦C1≦100 ppm. E1 is the standard electrode potential (V vs. SHE) of a redox pair Li/Li⁺, and E2 is the standard electrode potential (V vs. SHE) of a redox pair in the additive in expression (1); and Cl is the moisture content in 1 g of the material constituting the anode active material containing layer in expression (2).

### BACKGROUND OF THE INVENTION

1. Field of the Invention

The present invention relates to a lithium-ion secondary battery.

2. Related Background Art

Portable devices have developed remarkably in recent years, to which high-energy batteries such as lithium-ion secondary batteries contribute greatly. Along with developments of various portable devices, further advances in battery manufacturing techniques will be demanded from now on. A lithium-ion secondary battery is mainly constituted by a cathode, an anode, a separator, and a nonaqueous electrolytic solution. The cathode is formed by applying a mixture of a cathode active material (positive electrode active material), a conductive auxiliary agent, and a binder onto a collector; whereas the anode is formed by applying a mixture of an anode active material (negative electrode active material), a conductive auxiliary agent, and a binder onto the collector. In such a lithium-ion secondary battery, improvements on the cathode, anode, and nonaqueous electrolytic solution, which are its constituents, have recently been in progress in order to attain higher performances.

As a nonaqueous solvent of a nonaqueous electrolytic solution, propylene carbonate is suitable because of its high dielectric constant, low melting point, relatively wide potential window (electrochemical window), and excellent rate and low-temperature characteristics. In a case provided with an anode (negative electrode) using a carbon material such as highly crystallized graphite, however, there has been a problem of propylene carbonate decomposing in the cathode at the time of charging (i.e., the electrode functioning as the anode at the time of discharging) in particular. Therefore, a method has been under consideration, in which an additive is added to the nonaqueous electrolytic solution so as to restrain propylene carbonate from decomposing, thereby improving performances of the lithium-ion secondary battery. Known examples of such an additive include 1,3-propane sultone, 1,4-propane sultone, and vinylene carbonate (see, for example, Japanese Patent Application Laid-Open No. 2001-43895).

If moisture is contained in the cathode, anode, or nonaqueous electrolytic solution, ingredients in the nonaqueous electrolytic solution will react with the moisture and decompose, thereby lowering initial charging/discharging characteristics, charging/discharging cycle characteristics, storage characteristics, etc. Therefore, studies have been made in order to lower the moisture contained in the electrodes and nonaqueous electrolytic solution. For example, a lithium-ion secondary battery has been proposed, in which the moisture content is specified (lowered) so as to become 260 ppm or less with respect to 1 g of the positive electrode active material constituting the cathode in the positive electrode active material, 10 ppm or less with respect to 1 g of the negative electrode active material constituting the anode in the negative electrode active material, and 20 ppm or less with respect to the whole nonaqueous electrolytic solution in the nonaqueous electrolytic solution, in order to improve its initial charging/discharging characteristic and charging/discharging characteristic (see, for example, Japanese Patent Application Laid-Open No. 2001-297750).

### SUMMARY OF THE INVENTION

Since the lithium-ion secondary battery has an energy density much higher than that of the other batteries, it is also important for the battery to secure safety sufficiently during its use or storage when improving battery characteristics. The securing of safety becomes important in particular when a flammable nonaqueous electrolytic solution (an electrolytic solution including an organic solvent) is used as the electrolytic solution. Examples of standards for safety evaluation tests for lithium-ion secondary batteries include “UL1642” and “UL2054” of Underwriters Laboratories Inc., USA.

While lithium-ion secondary batteries have recently been required to attain higher density and higher capacity as power supplies for notebook-size laptop computers, electric cars, and power storage, it becomes harder to secure safety as the density and capacity increase. Even the conventional lithium-ion secondary batteries disclosed in Patent Documents 1 and 2 mentioned above have been hard to clear the heating test at 150° C. in the safety evaluation test standard “UL1642” for certain when achieving a higher capacity (for attaining a capacity of 2000 mAh or higher, or a capacity of 2500 mAh or higher).

In view of the problem of the conventional techniques mentioned above, it is an object of the present invention to provide a lithium-ion secondary battery which has excellent initial charging/discharging characteristic and charging/discharging cycle characteristic, and can attain sufficient safety even when intended to yield a higher capacity (a capacity of 2000 mAh or higher, or a capacity of 2500 mAh or higher).

The inventors conducted diligent studies in order to achieve the above-mentioned object and, as a result, have found that a configuration in which a specific additive is added into the nonaqueous electrolytic solution while a specific amount of moisture is intentionally present in the anode is quite effective in achieving the above-mentioned object, thereby attaining the present invention, although it has been a common knowledge of those skilled in the art to minimize the moisture content in the electrodes and nonaqueous electrolytic solution in order to reduce the amount of decomposing nonaqueous electrolyte components and improve performances of the lithium-ion secondary batteries.

Namely, the present invention provides a lithium-ion secondary battery comprising an anode including a conductive anode active material containing layer containing an anode active material; a cathode including a conductive cathode active material containing layer containing a cathode active material; a nonaqueous electrolytic solution containing a lithium salt, propylene carbonate, and a linear carbonate; and a case accommodating the anode, cathode, and nonaqueous electrolytic solution in a closed state. The nonaqueous electrolytic solution further contains an additive satisfying the condition represented by the following expression (1), and the moisture content in the anode active material containing layer is regulated so as to satisfy the condition represented by the following expression (2):
+0.9V≦(E2−E1)≦+2.5V (1)
40 ppm≦C1≦100 ppm (2)

E1 is the standard electrode potential (V vs. SHE) of a redox pair Li/Li⁺, and E2 is the standard electrode potential (V vs. SHE) of a redox pair of the additive in expression (1); whereas C1 is the moisture content in 1 g of the material constituting the anode active material containing layer in expression (2).

In the present invention, the electrodes to become the anode and cathode act as a reaction field where an electron transfer reaction in which a lithium ion (or metal lithium) is involved as a redox species can be advanced. Here, “advancing an electron transfer reaction” refers to the advancing of the electron transfer reaction within the range of battery life required for a power supply or auxiliary power supply of a device to be mounted therewith.

The anode active material contained as a constituent material in the anode and the cathode active material contained as a constituent material in the cathode are those contributing to the above-mentioned electron transfer reaction. The anode active material and cathode active material may be carbon materials or metal oxides having structures capable of occluding and releasing lithium ions or desorbing and inserting lithium ions (deintercalation/intercalation thereof) as well. Also, as the anode active material and/or cathode active material, a material such as a conductive polymer capable of reversibly advancing doping and undoping of lithium ions with their counter anions (e.g., ClO₄⁻) may be used alone or together with other active materials.

For convenience of explanation, the “anode” in the “anode active material” in the present invention refers to one (negative electrode active material) based on the polarity at the time of discharging the battery, whereas the “cathode” in the “cathode active material” in the present invention refers to one (positive electrode active material) based on the polarity at the time of discharging the battery. Specific examples of the anode active material and cathode active material will be set forth later.

“SHE” refers to the (potential of the) standard hydrogen electrode, i.e., 0 V.

The configuration in which the additive contained in the nonaqueous electrolytic solution satisfies the condition of the above-mentioned expression (1) whereas the moisture content in the anode active material containing layer satisfies the condition of the above-mentioned expression (2) allows the lithium-ion secondary battery of the present invention to exhibit excellent initial charging/discharging characteristic and charging/discharging cycle characteristic, while having sufficient safety even when achieving a high capacity. Namely, the lithium-ion secondary battery of the present invention can reliably clear the 150° C. heating test of “UL1642” even when achieving a higher capacity (a capacity of 2000 mAh or higher, or a capacity of 2500 mAh or higher in particular).

The present invention can attain the above-mentioned effects, and thus can construct a lithium-ion secondary battery having a capacity of 2000 mAh to 5000 mAh (preferably 2500 mAh to 4000 mAh) which has conventionally been hard to reliably clear the 150° C. heating test of “UL1642”.

Though no detailed mechanism by which the above-mentioned effects are obtained have been elucidated clearly, the inventors consider as follows. Namely, it is presumed to be because the additive satisfying the condition of expression (1) and the moisture content satisfying the condition of expression (2) efficiently form a chemically stable film which can fully suppress the reductive decomposition of propylene carbonate on the anode surface.

When an additive in which (E2−E1) is less than +0.9 V is used, the decomposition of propylene carbonate advances, so that discharging characteristics remarkably deteriorate. This seems to be because a film which suppresses the reductive decomposition of propylene carbonate cannot be formed on the anode surface. When an additive in which (E2−E1) exceeds +2.5 V is used, the charging/discharging characteristic of the lithium-ion secondary battery deteriorates. This seems to be because the film is not selectively formed on the anode surface alone.

When the moisture content in 1 g of the material constituting the anode active material containing layer is less than 40 ppm (i.e., the moisture content in the anode active material containing layer is insufficient), the 150° C. heating test of “UL1642” cannot reliably be cleared. When the moisture content of 1 g of the material constituting the anode active material containing layer exceeds 100 ppm (i.e., the moisture content in the anode active material containing layer is in excess), on the other hand, sufficient charging/discharging characteristics and charging/discharging cycle characteristics cannot be obtained.

Here, the “material constituting the anode active material containing layer” refers to a material containing at least an anode active material and forming the anode active material containing layer.

Preferably, the present invention uses, as the material constituting the anode active material containing layer, at least the anode active material and a binder adapted to bind particles of the anode active material to each other. In this case, it will be preferred from the viewpoint of more reliably achieving the effects of the present invention if the anode active material and binder in the anode active material containing layer have respective contents A and B [mass %] satisfying the conditions represented by the following expressions (3) and (4):
70≦A≦97 (3)
3≦B≦10 (4)

Preferably, a conductive auxiliary agent is further used as the material constituting the anode active material containing layer. It will be preferred in this case if the conductive auxiliary agent in the anode active material containing layer has a content of 25 mass % or less.

In the present invention, at least one species selected from the group consisting of diethyl carbonate, dimethyl carbonate, and ethylmethyl carbonate can be used as the linear carbonate contained in the nonaqueous electrolytic solution.

In the present invention, from the viewpoint of restraining gases from occurring at the time of storage at a high temperature, it will be preferred if the linear carbonate is diethyl carbonate.

Though the respective contents [vol %] of propylene carbonate and linear carbonate contained in the nonaqueous electrolytic solution are not restricted in particular, it will be preferred from the viewpoint of more reliably attaining the effects of the present invention if propylene carbonate and linear carbonate fall within the respective ranges of 10 to 60 vol % and 30 to 80 vol %. When the propylene carbonate (PC) content in the nonaqueous electrolytic solution exceeds 60 vol %, the decomposition reaction of PC is more likely to advance. When the propylene carbonate content is less than 10 vol %, a sufficient charging/discharging characteristic is less likely to be obtained at a low temperature (−20° to +25° C.). When the linear carbonate content is less than 30 vol %, a sufficient high-rate discharging characteristic is less likely to be obtained. Also, a sufficient charging/discharging characteristic is less likely to be obtained at a low temperature (−20° to +25° C.). When the linear carbonate content exceeds 80 vol %, a sufficient charging capacity is less likely to be obtained.

Though the amount of addition of the additive is not restricted in particular in the present invention, it will be preferred if the total additive amount is 1 to 10 parts by mass with respect to 100 parts by mass of the nonaqueous electrolytic solution. Within such a range, the above-mentioned effects of the present invention can be obtained more reliably while securing a sufficient capacity.

For forming a more stable film, it will be preferred in the present invention if the nonaqueous electrolytic solution further contains ethylene carbonate.

Preferably, in this case, propylene carbonate, ethylene carbonate, and the linear carbonate have respective contents X, Y, and Z [vol %] simultaneously satisfying the conditions of the following expressions (6) to (9):
10≦X≦60 (6)
1≦Y≦20 (7)
30≦Z≦80 (8)
X+Y+Z=100 (9)

When the nonaqueous electrolytic solution contains propylene carbonate, ethylene carbonate, and the linear carbonate, it will be preferred from the viewpoint of more reliably attaining the above-mentioned effects of the present invention if the above-mentioned conditions are satisfied simultaneously. When the propylene carbonate content in the nonaqueous electrolytic solution exceeds 60 vol %, the decomposition reaction of PC is more likely to advance. When the propylene carbonate content is less than 10 vol %, a sufficient charging/discharging characteristic is less likely to be obtained at a low temperature (−200 to +25° C.). When the linear carbonate content is less than 30 vol %, a sufficient high-rate discharging characteristic is less likely to be obtained. Also, a sufficient charging/discharging characteristic is less likely to be obtained at a low temperature (−20° to +25° C.). When the linear carbonate content exceeds 80 vol %, a sufficient charging capacity is less likely to be obtained. When the ethylene carbonate content is less than 1 vol %, the decomposition reaction of polyethylene carbonate is more likely to advance. When the ethylene carbonate content exceeds 20 vol %, a sufficient charging/discharging characteristic is less likely to be obtained at a low temperature (−200 to +25° C.).

Preferably used as the additive satisfying the above-mentioned expression (1) in the present invention is at least one species of compound selected from the group consisting of respective compounds represented by the following general formulas (I), (II), and (III): 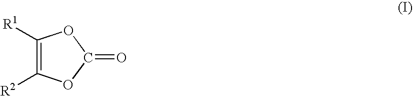
where R¹ and R² are either identical or different from each other and indicate any of hydrogen atom and hydrocarbon groups having a carbon number of 1 to 6; 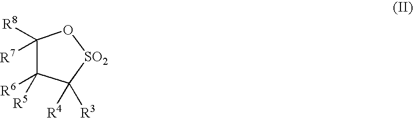
where R³, R⁴, R⁵, R⁶, R⁷, and R⁸ are either identical or different from each other and indicate any of hydrogen atom and hydrocarbon groups having a carbon number of 1 to 3; and 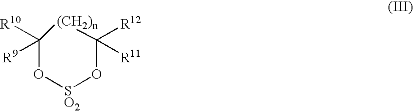
where R⁹, R¹⁰, R¹¹, and R¹² are either identical or different from each other and indicate any of hydrogen atom and hydrocarbon groups having a carbon number of 1 to 4, and n is 0 or 1.

Using the above-mentioned compounds can more reliably restrain propylene carbonate from decomposing and more reliably attain the effects of the present invention.

Though the amount of addition of the compounds represented by the above-mentioned general formulas (I) to (III) is not restricted in particular, it will be preferred if the total amount of the compounds in use is 1 to 10 parts by mass with respect to 100 parts by mass of the nonaqueous electrolytic solution. Within such a range, the above-mentioned effects of the present invention can be obtained more reliably while securing a sufficient capacity.

Preferably, the present invention uses vinylene carbonate in which each of R¹ and R² in the compound represented by the above-mentioned general formula (I) is hydrogen atom. Vinylene carbonate is a compound satisfying the above-mentioned expression (1) [i.e., (E2−E1) is +1.3 V], whereby the effects of the present invention can be obtained more reliably. A preferred range of its amount of addition is 1 to 10 parts by mass with respect to 100 parts by mass of the nonaqueous electrolytic solution. It is also preferred to use 1,3-propane sultone in which each of R³, R⁴, R⁵, R⁶, R⁷, and R⁸ in the compound represented by the above-mentioned general formula (II) is hydrogen atom. 1,3-propane sultone is a compound satisfying the above-mentioned expression (1) [i.e., (E2−E1) is +1.3 V], whereby the effects of the present invention can be obtained more reliably. A preferred range of its amount of addition is 1 to 10 parts by mass with respect to 100 parts by mass of the nonaqueous electrolytic solution.

It is also preferred to use 1,3,2-dioxathiolane-2,2-dioxide in which each of R⁹, R¹⁰, R¹¹, R¹², R¹³ and R¹⁴ in the compound represented by the above-mentioned general formula (III) is hydrogen atom. 1,3,2-dioxathiolane-2,2-dioxide is a compound satisfying the above-mentioned expression (1) [i.e., (E2−E1) is +1.9 V], whereby the effects of the present invention can be obtained more reliably. A preferred range of its amount of addition is 1 to 10 parts by mass with respect to 100 parts by mass of the nonaqueous electrolytic solution.

The above-mentioned compounds (vinylene carbonate, 1,3-propane sultone, and 1,3,2-dioxathiolane-2,2-dioxide) may be used singly or in combination. When used in combination, the ratio of respective amounts of addition of the compounds is not restricted in particular as long as they fall within a range in which the effects of the present invention are obtained. When vinylene carbonate (which will hereinafter be referred to as “VC” as necessary) and 1,3-propane sultone (which will hereinafter be referred to as “PS”) are used, for example, it will be more preferred if the mass ratio VC/PS of these compounds is 0.01 to 0.30.

Preferably, the lithium-ion secondary battery of the present invention further comprises a porous separator disposed between the anode and cathode, whereas the separator is impregnated with the nonaqueous electrolytic solution. The porous separator is not restricted in particular as long as it is formed from an insulating porous body, whereby separators used in known lithium-ion secondary batteries can be employed. Examples of the insulating porous body include laminates of films made of polyethylene, polypropylene, and polyolefins, extended films of mixtures of the resins mentioned above, and fibrous nonwoven fabrics constituted by at least one species selected from the group consisting of cellulose, polyester, and polypropylene.

As mentioned above, the lithium-ion secondary battery of the present invention can attain sufficient safety even when intended to yield a higher capacity, whereby the battery capacity may be 2000 mAh to 5000 mAh. Further, the battery capacity may be 2500 mAh to 4000 mAh.

### BRIEF DESCRIPTION OF THE DRAWINGS

FIG. 1 is a front view showing a preferred embodiment of the lithium-ion secondary battery in accordance with the present invention;

FIG. 2 is an unfolded view of the inside of lithium-ion secondary battery shown in FIG. 1 as seen in a direction normal to the surface of an anode 10;

FIG. 3 is a schematic sectional view of the lithium-ion secondary battery shown in FIG. 1 taken along the line X1-X1 thereof;

FIG. 4 is a schematic sectional view illustrating a major part of the lithium-ion secondary battery shown in FIG. 1 taken along the line X2-X2 thereof;

FIG. 5 is a schematic sectional view illustrating a major part of the lithium-ion secondary battery shown in FIG. 1 taken along the line Y-Y thereof;

FIG. 6 is a schematic sectional view illustrating an example of basic configuration of a film to become a constituent material of a case of the lithium-ion secondary battery shown in FIG. 1;

FIG. 7 is a schematic sectional view illustrating another example of basic configuration of the film to become a constituent material of the case of the lithium-ion secondary battery shown in FIG. 1;

FIG. 8 is a schematic sectional view showing an example of basic configuration of the anode of the lithium-ion secondary battery shown in FIG. 1;

FIG. 9 is a schematic sectional view showing an example of basic configuration of a cathode of the lithium-ion secondary battery shown in FIG. 1; and

FIG. 10 is a schematic sectional view showing an example of basic configuration of a laminate employed in another preferred embodiment of the lithium-ion secondary battery in accordance with the present invention.

### DESCRIPTION OF THE PREFERRED EMBODIMENTS

In the following, with reference to the drawings, preferred embodiments of the lithium-ion secondary battery in accordance with the present invention will be explained in detail. In the following explanation, parts identical or equivalent to each other will be referred to with numerals identical to each other without repeating their overlapping descriptions.

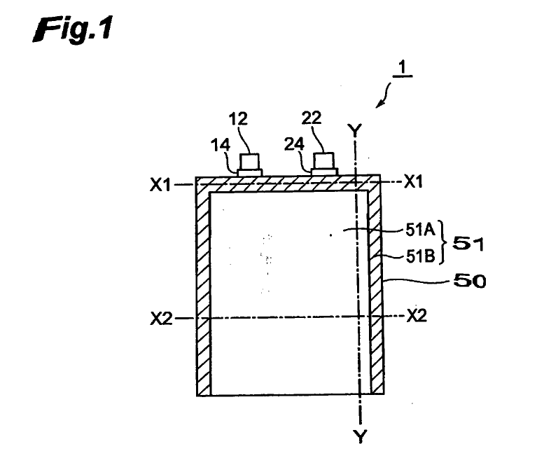

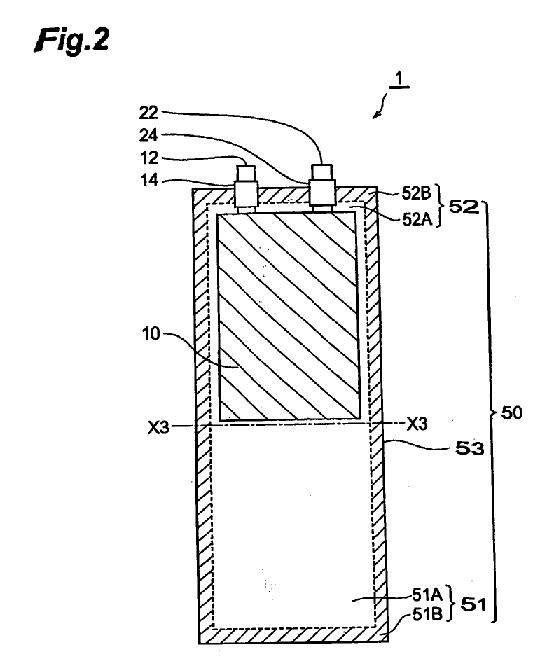

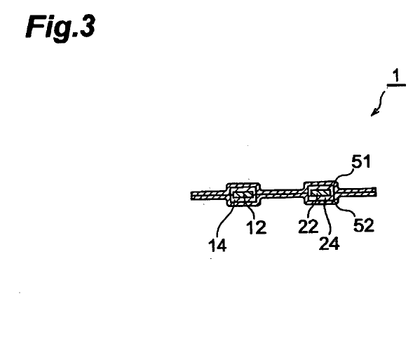

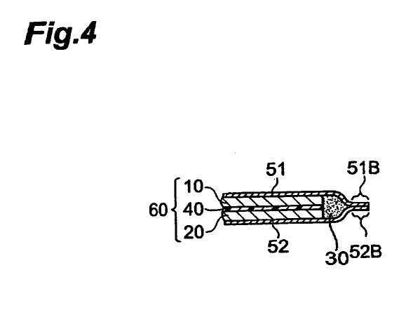

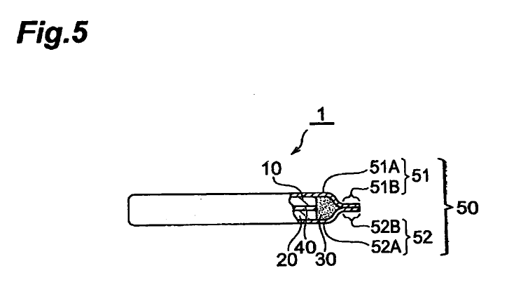

FIG. 1 is a front view showing a preferred embodiment of the lithium-ion secondary battery in accordance with the present invention. FIG. 2 is an unfolded view of the inside of the lithium-ion secondary battery shown in FIG. 1 as seen in a direction normal to the surface of the anode 10. FIG. 3 is a schematic sectional view of the lithium-ion secondary battery shown in FIG. 1 taken along the line X1-X1 thereof. FIG. 4 is a schematic sectional view illustrating a major part of the lithium-ion secondary battery shown in FIG. 1 taken along the line X2-X2 thereof. FIG. 5 is a schematic sectional view illustrating a major part of the lithium-ion secondary battery shown in FIG. 1 taken along the line Y-Y thereof.

As shown in FIGS. 1 to 5, the lithium-ion secondary battery 1 is mainly constituted by a planar anode 10 and a planar cathode 20 which oppose each other; a planar separator 40 disposed between the anode 10 and cathode 20 adjacent thereto; a nonaqueous electrolytic solution 30; a case 50 accommodating them in a closed state; an anode lead 12 having one end part electrically connected to the anode 10 and the other end part projecting out of the case 50; and a cathode lead 22 having one end part electrically connected to the cathode 20 and the other end part projecting out of the case 50. For convenience of explanation, the “anode” 10 and “cathode” 20 are determined according to polarities of the lithium-ion secondary battery 1 at the time of discharging. Therefore, at the time of charging, the “anode 10” and “cathode 20” become “cathode” and “anode”, respectively. The above-mentioned “planar” encompasses flat and curved plate forms.

For achieving the above-mentioned object of the present invention, the lithium-ion secondary battery 1 has the configuration explained in the following.

With reference to FIGS. 1 to 9, the individual constituents of this embodiment will be explained in detail.

The case 50 is formed by using a pair of films (a first film 51 and a second film 52) opposing each other. As shown in FIG. 2, the first film 51 and second film 52 in this embodiment are joined to each other. A rectangular film made of a single composite package film is folded at a fold line X3-X3 shown in FIG. 2, so that a pair of opposing fringes of the rectangular film (a fringe 51B of the first film 51 and a fringe 52B of the second film 52 in the drawing) are overlaid on each other and sealed with an adhesive or by heat, whereby the case 50 in this embodiment is formed.

The first film 51 and second film 52 represent respective film parts having surfaces opposing each other when a single rectangular film 53 is folded as mentioned above. In this specification, the respective fringes of the first film 51 and second film 52 after being joined together are referred to as “seal parts”.

This makes it unnecessary to provide a seal part for joining the first film 51 and second film 52 to each other at the part of fold line X3-X3, whereby seal parts in the case 50 can further be reduced. As a result, the volume energy density based on the volume of a space where the lithium-ion secondary battery 1 is to be placed can further be improved.

In this embodiment, as shown in FIGS. 1 and 2, respective one ends of the anode lead 12 connected to the anode 10 and the cathode lead 22 are arranged so as to project out of the above-mentioned seal parts where the fringe 51B of the first film 51 and the fringe 52B of the second film 52 are joined to each other.

The film constituting the first film 51 and second film 52 is a flexible film. Since the film is light in weight and can easily be made thinner, the lithium-ion secondary battery itself can be formed like a thin film. This can easily improve the original volume energy density and the volume energy density based on the volume of the space where the lithium-ion secondary battery is to be placed.

The film is not restricted in particular as long as it is a flexible film. However, from the viewpoint of securing a sufficient mechanical strength and lightweight of the case 50 while effectively preventing the moisture and air from entering the case 50 from the outside and dissipating electrolyte components from the inside of the case 50 to the outside, it is preferably a “composite package film” comprising, at least, an innermost layer made of a synthetic resin in contact with the electrolytic solution 30, and a metal layer disposed on the upper side of the innermost layer.

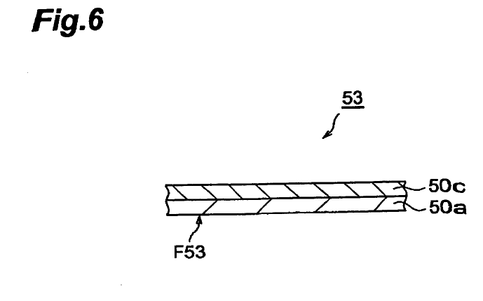

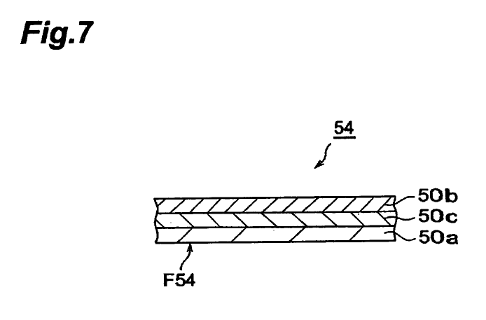

Examples of composite package films usable as the first film 51 and second film 52 include those having the configurations shown in FIGS. 6 and 7. The composite package film 53 shown in FIG. 6 comprises an innermost layer 50a made of a synthetic resin in contact with the electrolytic solution 30 by its inner face F53, and a metal layer 50c disposed on the other surface (outer face) of the innermost layer 50a. The composite package film 54 shown in FIG. 7 has a configuration in which an outermost layer 50b made of a synthetic resin is further disposed on the metal layer 50c of the composite package film 53 shown in FIG. 6.

The composite package film usable as the first film 51 and second film 52 is not limited in particular as long as it is a composite package film comprising at least two layers composed of at least one synthetic resin layer such as the above-mentioned innermost layer, and a metal layer made of a metal foil or the like. From the viewpoint of more reliably attaining the same effects as those mentioned above, however, it will be more preferred if the film is constituted by at least three layers comprising the innermost layer 50a in contact with the nonaqueous electrolytic solution 30 by its inner face F54, the outermost layer 50b made of a synthetic resin disposed on the outer surface side of the case 50 farthest from the innermost layer 50a, and at least one metal layer 50c disposed between the innermost layer 50a and outermost layer 50b as with the composite package film 54 shown in FIG. 7.

The innermost layer 50a is a flexible layer. The constituent material of this layer is not limited in particular as long as it is a synthetic resin which can express the flexibility mentioned above, and has chemical stability (property of causing no chemical reaction, no dissolution, and no swelling) with respect to the nonaqueous electrolytic solution 30 in use and chemical stability with respect to oxygen and water (moisture in the air). Preferred is a material further having a property of low permeability to oxygen, water (moisture in the air), and components of the nonaqueous electrolytic solution 30. Examples of such a synthetic resin include engineering plastics, and thermoplastic resins such as polyethylene, polypropylene, acid-denatured polyethylene, acid-denatured polypropylene, polyethylene ionomers, and polypropylene ionomers.

The “engineering plastics” refer to plastics having such excellent dynamic properties, heat resistance, and durability as to be usable in mechanical parts, electric parts, housing materials, etc. Their examples include polyacetal, polyamide, polycarbonate, polyoxytetramethylene terephthaloyl (polybutylene terephthalate), polyethylene terephthalate, polyimide, and polyphenylene sulfide.

When a layer made of a synthetic resin such as the outermost layer 50b is further provided in addition to the innermost layer 50a as in the composite package film 54 shown in FIG. 7 mentioned above, this synthetic resin layer may use a constituent material similar to that of the innermost layer.

Preferably, the metal layer 50c is a layer made of a metal material having an anticorrosion property against oxygen, water (moisture in the air), and the nonaqueous electrolytic solution 30. Metal foils made of aluminum, aluminum alloys, titanium, and chromium, for example, may be used.

Though not restricted in particular, the method of sealing all the seal parts in the case 50 is preferably heat sealing from the viewpoint of productivity.

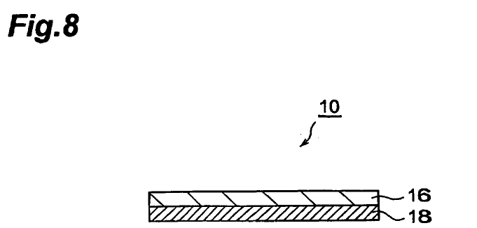

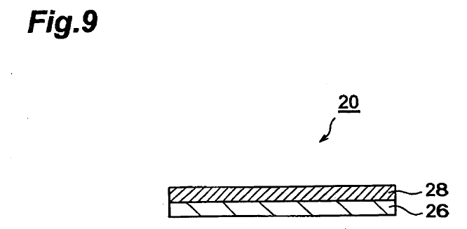

The anode 10 and cathode 20 will now be explained. FIG. 8 is a schematic sectional view showing an example of basic configuration of the anode in the lithium-ion secondary battery shown in FIG. 1. FIG. 9 is a schematic sectional view showing an example of basic configuration of the cathode in the lithium-ion secondary battery shown in FIG. 1.

As shown in FIG. 8, the anode 10 comprises a collector 16, and an anode active material containing layer 18 formed on the collector 16. As shown in FIG. 9, the cathode 20 comprises a collector 26, and a cathode active material containing layer 28 formed on the collector 26.

The collectors 16 and 26 are not restricted in particular as long as they are conductors which can sufficiently transfer electric charges to the anode active material containing layer 18 and the cathode active material containing layer 28, respectively, whereby known collectors used in lithium-ion secondary batteries can be employed. Examples of the collectors 16 and 26 include foils of metals such as aluminum and copper.

The anode active material containing layer 18 of the anode 10 is mainly constituted by an anode active material, a conductive auxiliary agent, and a binder.

The anode active material is not restricted in particular as long as it can reversibly proceed with occlusion/release of lithium ions, desorption/insertion (deintercalation/intercalation) of lithium ions, or doping/undoping of lithium ions with their counter anions (e.g., ClO₄⁻), whereby known anode active materials can be used. Examples of such an active material include carbon materials such as natural graphite, synthetic graphite (carbons which are easy to graphitize, carbons which are hard to graphitize, carbons fired at a low temperature, etc.), metals such as Al, Si, and Sn which are combinable with lithium, amorphous compounds mainly composed of oxides such as SiO₂ and SnO₂, and lithium titanate (Li₄Ti₅O₁₂).

Preferred among them are carbon materials. More preferred are those having an interlayer distance d₀₀₂ of 0.335 to 0.338 nm and a crystallite size Lc₀₀₂ of 30 to 120 nm. Examples of carbon materials satisfying such conditions include synthetic graphite and MCF (mesocarbon fiber). The above-mentioned interlayer distance d₀₀₂ and crystallite size Lc₀₀₂ can be determined by X-ray diffraction.

The amount of decomposition of propylene carbonate has conventionally been large when propylene carbonate is employed as a constituent of a nonaqueous solvent in the case where a carbon material is used as an anode active material in particular. The present invention can sufficiently suppress the decomposition of propylene carbonate by adding an additive which will be explained later to the nonaqueous electrolytic solution 30 and adjusting the moisture content in the anode active material containing layer 18 as will be explained later.

The conductive auxiliary agent is not restricted in particular, whereby known conductive auxiliary agents can be used. Examples of the conductive auxiliary agent include carbon blacks; carbon materials; fine powders of metals such as copper, nickel, stainless, and iron; mixtures of the carbon materials and fine powders of metals; and conductive oxides such as ITO.

The binder is not restricted in particular as long as it can bind particles of the anode active material and particles of the conductive auxiliary agent to each other. Its examples include fluorine resins such as polyvinylidene fluoride (PVDF), polytetrafluoroethylene (PTFE), tetrafluoroethylene/hexafluoropropylene copolymer (FEP), tetrafluoroethylene/perfluoroalkylvinylether copolymer (PFA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF). This binder contributes not only to binding the particles of the anode active material and particles of the conductive auxiliary agent to each other as mentioned above, but also to binding them to the foil (collector 16).

When the anode active material, the conductive auxiliary agent, and the binder are used as the material constituting the anode active material containing layer, it will be preferred if their contents in the anode active material containing layer fall within the ranges of 70 to 97 mass %, 0 to 25 mass %, and 3 to 10 mass %, respectively.

In the present invention, the moisture content in the anode active material containing layer 18 is regulated so as to become 40 to 100 ppm in 1 g of the material constituting the anode active material containing layer 18. A method of regulating the moisture content will be explained later.

The cathode active material containing layer 28 of the cathode 20 is mainly constituted by a cathode active material, a conductive auxiliary agent, and a binder as with the anode active material containing layer 18.

The cathode active material is not restricted in particular as long as it can reversibly proceed with occlusion/release of lithium ions, desorption/insertion (deintercalation/intercalation) of lithium ions, or doping/undoping of lithium ions with their counter anions (e.g., ClO₄⁻), whereby known anode active materials can be used. Examples of such an active material include mixed metal oxides such as lithium cobaltate (LiCoO₂), lithium nickelate (LiNiO₂), lithium manganese spinel (LiMn₂O₄), those represented by a general formula of LiNiₓCo_{y}Mn_{z}O₂ (x+y+z=1), lithium vanadium compound (LiV₂O₅), olivine-type LiMPO₄ (where M is Co, Ni, Mn, or Fe), and lithium titanate (Li₄Ti₅O₁₂).

As the constituent materials other than the cathode active material contained in the cathode active material containing layer 28, those constituting the anode active material containing layer 18 can be used as well. The binder contained in the cathode active material containing layer 28 contributes not only to binding particles of the cathode active material and particles of the conductive auxiliary agent to each other as mentioned above, but also to binding them to the foil (collector 26).

The collector 28 of the cathode 20 is electrically connected to one end of the cathode lead 22 made of aluminum, for example, whereas the other end of the cathode lead 22 projects out of the case 50. On the other hand, the collector 18 of the anode 10 is electrically connected to one end of the anode lead 12 made of copper or nickel, for example, whereas the other end of the anode lead 12 projects out of the case 14.

The separator 40 disposed between the anode 10 and cathode 20 is not restricted in particular as long as it is formed from an insulating porous body, whereby known separators used in lithium-ion secondary batteries can be employed. Examples of the insulating porous body include laminates of films made of polyethylene, polypropylene, and polyolefin, extended films of mixtures of the resins mentioned above, and fibrous nonwoven fabrics made of at least one species of constituent material selected from the group consisting of cellulose, polyester, and polypropylene.

The inner space of the case 50 is filled with the nonaqueous electrolytic solution 30, which is partly contained within the anode 10, cathode 20, and separator 40. The nonaqueous electrolytic solution 30 contains a lithium salt, propylene carbonate and a linear carbonate as a nonaqueous solvent, and an additive.

Examples of the lithium ion employed include salts such as LiPF₆, LiClO₄, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), and LiN(CF₃CF₂CO)₂. These salts may be used singly or in combination of two or more species. The nonaqueous electrolytic solution 30 may be gelled by a gelling agent such as a gel polymer added thereto.

The nonaqueous electrolytic solution 30 may further contain ethylene carbonate in addition to propylene carbonate and the linear carbonate as the nonaqueous solvent. In this case, from the viewpoint of more reliably attaining the effects of the present invention mentioned above, it will be preferred if propylene carbonate, ethylene carbonate, and the linear carbonate have respective contents X, Y, and Z [vol %] simultaneously satisfying the conditions of the following expressions (6) to (9):
10≦X≦60 (6)
1≦Y≦20 (7)
30≦Z≦80 (8)
X+Y+Z=100 (9)

When the propylene carbonate content in the nonaqueous electrolytic solution exceeds 60 vol %, the decomposition reaction of PC is more likely to advance. When the propylene carbonate content is less than 10 vol %, a sufficient charging/discharging characteristic is less likely to be obtained at a low temperature (−20° to +25° C.). When the linear carbonate content is less than 30 vol %, a sufficient high-rate discharging characteristic is less likely to be obtained. Also, a sufficient charging/discharging characteristic is less likely to be obtained at a low temperature (−20° to +25° C.). When the linear carbonate content exceeds 80 vol %, a sufficient charging capacity is less likely to be obtained. When the ethylene carbonate content is less than 1 vol %, the decomposition reaction of polyethylene carbonate is more likely to advance. When the ethylene carbonate content exceeds 20 vol %, a sufficient charging/discharging characteristic is less likely to be obtained at a low temperature (−200 to +25° C.).

Examples of the linear carbonate include diethyl carbonate, dimethyl carbonate, and ethylmethyl carbonate. Preferably, diethyl carbonate is used in the present invention.

As mentioned above, the additive contained in the nonaqueous electrolytic solution 30 satisfies the condition represented by the following expression (1):
+0.9V≦(E2−E1)≦+2.5V (1)
where E1 is the standard electrode potential (V vs. SHE) of a redox pair Li/Li⁺, and E2 is the standard electrode potential (V vs. SHE) of a redox pair of the additive in expression (1).

Examples of the additive satisfying the above-mentioned condition include respective compounds represented by the following formulas (I), (II), and (III). At least one species of them can be added. 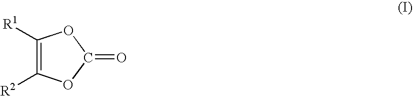
where R¹ and R² are either identical or different from each other and indicate any of hydrogen atom and hydrocarbon groups having a carbon number of 1 to 6; 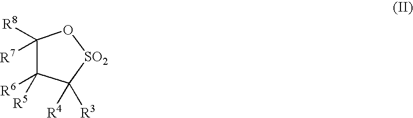
where R³, R⁴, R⁵, R⁶, R⁷, and R⁸ are either identical or different from each other and indicate any of hydrogen atom and hydrocarbon groups having a carbon number of 1 to 3; and 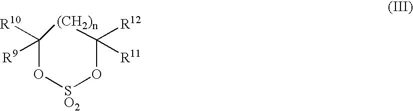
where R⁹, R¹⁰, R¹¹ and R¹² are either identical or different from each other and indicate any of hydrogen atom and hydrocarbon groups having a carbon number of 1 to 4, and n is 0 or 1.

The amount of addition of the above-mentioned additive is not restricted in particular, but it will be preferred if the total additive amount is 1 to 10 parts by mass with respect to 100 parts by mass of the nonaqueous electrolytic solution. Within such a range, the above-mentioned effects of the present invention can be obtained more reliably while securing a sufficient capacity.

More specifically, vinylene carbonate in which each of R¹ and R² in the compound represented by the above-mentioned general formula (I) is hydrogen atom, 1,3-propane sultone in which each of R³, R⁴, R⁵, R⁶, R⁷, and R⁸ in the compound represented by the above-mentioned general formula (II) is hydrogen atom, and 1,3,2-dioxathiolane-2,2-dioxide in which each of R⁹, R¹⁰, R¹¹, and R¹² in the compound represented by the above mentioned general formula (III) is hydrogen atom are favorably employable.

The above-mentioned compounds (vinylene carbonate, 1,3-propane sultone, and 1,3,2-dioxathiolane-2,2-dioxide) may be used either singly or in combination. When used in combination, the ratio of respective amounts of addition of the compounds is not restricted in particular as long as they fall within the range where the effects of the present invention are obtained. When vinylene carbonate and 1,3-propane sultone are used in combination, for example, it will be preferred if their mass ratio VC/PS is 0.01 to 0.30.

As shown in FIGS. 1 and 2, the part of the anode lead 12 coming into contact with the seal part of a sealing bag constituted by the fringe 51B of the first film 51 and the fringe 52B of the second film 52 is covered with an insulator 14 for preventing the anode lead 12 and the metal layer in the composite package film constituting the individual films from electrically coming into contact with each other. Further, the part of the cathode lead 22 coming into contact with the seal part of the sealing bag constituted by the fringe 51B of the first film 51 and the fringe 52B of the second film 52 is covered with an insulator 24 for preventing the cathode lead 22 and the metal layer in the composite package film constituting the individual films from electrically coming into contact with each other.

The configurations of the insulators 14 and 24 are not restricted in particular, and may be formed from synthetic resins, for example. If the metal layer in the composite package film can sufficiently be prevented from coming into contact with the anode lead 12 and cathode lead 22, the insulators 14 and 24 may be omitted.

A method of making the above-mentioned case 50 and lithium-ion secondary battery 1 will now be explained.

The method of manufacturing a element 60 (a laminate in which the anode 10, separator 40, and cathode 20 are successively laminated in this order) is not limited in particular, whereby known thin film manufacturing techniques employed in the making of known lithium-ion secondary batteries can be used.

First, when making the anode 10 and cathode 20, the above-mentioned constituents are mixed and then dispersed into a solvent adapted to dissolve the binder, so as to make an electrode forming coating liquid (slurry or the like). The solvent is not restricted in particular as long as it is adapted to dissolve the binder and disperse the conductive auxiliary agent. For example, N-methyl-2-pyrrolidone and N,N-dimethylformamide can be used.

Subsequently, the above-mentioned electrode forming coating liquid is applied onto its corresponding collector surface, and is dried and extended, so as to form an active material containing layer on the collector, whereby the making of the anode 10 and cathode 20 is completed. The technique for applying the electrode forming coating liquid onto the collector surface is not restricted in particular, and may be determined appropriately according to the material, form, and the like of the collector. Examples of the technique include metal mask printing, electrostatic coating, dip coating, spray coating, roll coating, doctor blading, gravure coating, and screen printing.

When forming the electrodes, the anode and cathode may be formed by so-called dry methods without preparing the electrode forming coating liquid. For example, the anode can be made by the following procedure when using a dry method. First, a powder containing the anode active material, conductive auxiliary agent, and binder is prepared by a known powder manufacturing technique. Thus obtained powder is introduced between a pair of hot rolls in a hot roll press, so as to be formed into a sheet under heat and pressure. The resulting sheet is laminated with a collector, so as to yield the anode. Using a method in which the powder is heated and pressed so as to form a sheet can eliminate the step of laminating the sheet and collector.

The anode lead 12 and cathode lead 22 are electrically connected to thus prepared anode 10 and cathode 20, respectively. The separator 40 is disposed between the anode 10 and cathode 20 while in contact therewith (in a nonbonding state), whereby the element 60 is completed.

It is necessary for the lithium-ion secondary battery of the present invention to regulate the moisture content in the anode active material containing layer so as to yield a moisture content of 40 to 100 ppm in 1 g of the material constituting the anode active material containing layer. This amount of moisture can be regulated by drying the element 60 at a predetermined temperature under vacuum after making the same.

An example of method of making the case 50 will now be explained. First, when constructing the first and second films from the above-mentioned composite package film, a known manufacturing method such as dry lamination, wet lamination, hotmelt lamination, or extrusion lamination is used.

For example, a film to become a layer made of a synthetic resin and a metal foil made of aluminum or the like which constitute a composite package film are prepared. The metal foil can be prepared by extending a metal material, for example.

Next, the metal foil is bonded by way of an adhesive onto the film to become the synthetic resin layer, and so forth, so as to yield the above-mentioned configuration preferably composed of a plurality of layers, thereby making a composite package film (multilayer film). Then, the composite package film is cut into a predetermined size, so as to prepare a single rectangular film.

Subsequently, as previously explained with reference to FIG. 2, the single film is folded, and the seal part 51B (fringe 51B) of the first film 51 and the seal part 52B (fringe 52B) of the second film 52 are heat-sealed by a desirable width with a sealer under a predetermined heating condition, for example. Here, for securing an opening for introducing the element 60 into the case 50, a part is left without being heat-sealed. This yields the case 50 with an opening.

Then, the element 60 having the anode lead 12 and cathode lead 22 electrically connected thereto is inserted into the case 50 in the state provided with the opening. Thereafter, the nonaqueous electrolytic solution 30 is injected. Subsequently, while the anode lead 12 and cathode lead 22 are partly inserted in the case 50, the opening of the case 50 is sealed with a sealer. Thus, the making of the case 50 and lithium-ion secondary battery 1 is completed. The lithium-ion secondary battery of the present invention is not limited to one having such a form, but may have a cylindrical form or the like.

Though a preferred embodiment of the present invention is explained in the foregoing, the present invention is not limited to the above-mentioned embodiment.

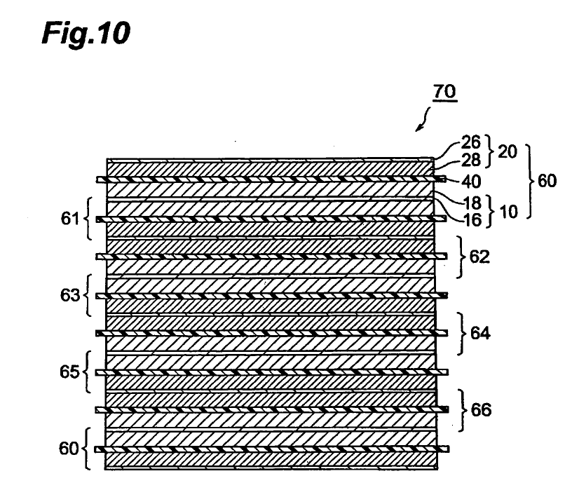

For example, though the lithium-ion secondary battery 1 is made by using a single element 60, a laminate in which a plurality of elements 60 are laminated as shown in FIG. 10 may be used as well. Among the elements constituting the laminate 70 in FIG. 10, the elements 61, 62, 63, 64, 65, 66 other than the elements 60 at both ends have collectors in common with their adjacent elements. For example, the elements 60 and 61 commonly use the collector 16, whereas the elements 61 and 62 commonly use the collector 26. Laminating a plurality of elements as such can yield a lithium-ion secondary battery having a desirable capacity.

### EXAMPLES

In the following, the present invention will be explained in further detail with reference to Examples and Comparative Examples. However, the present invention is not restricted to these examples at all.

In the following procedures, lithium-ion secondary batteries in accordance with Examples 1 to 4 and Comparative Examples 1 to 3 including laminates configured similar to the laminate of FIG. 10 were made.

### Example 1

An anode was made. First, synthetic graphite (90 parts by mass) as an anode active material, carbon black (2 parts by mass) as a conductive auxiliary agent, and polyvinylidene fluoride (PVDF) (8 parts by mass) as a binder were mixed by a planetary mixer, and an appropriate amount of N-methyl pyrrolidone (NMP) was added thereto as a solvent, whereby a slurry was obtained. The slurry was applied by doctor blading onto an electrolytic copper foil (having a thickness of 15 μm) acting as a collector and then dried such that the supported amount of anode active material became 14.0 mg/cm², so as to form an anode active material containing layer. The dried product was pressed by calender rolls such that the porosity of the resulting anode became 30%, and then was punched out into a size of 83 mm×102 mm, so as to yield the anode.

Next, a cathode was made. First, Li_{0.33}CO_{0.34}Mn_{0.33}O₂ (the numbers in the formula being atom ratios) (90 parts by mass) as a positive electrode active material, acetylene black (6 parts by mass) as a conductive auxiliary agent, and PVDF (4 parts by mass) as a binder were mixed by a planetary mixer, and an appropriate amount of N-methylpyrrolidone (NMP) was added thereto as a solvent, whereby a slurry was obtained. The slurry was applied by doctor blading onto an aluminum foil (having a thickness of 20 μm) acting as a collector and then dried such that the supported amount of cathode active material became 26.5 mg/cm², so as to form a cathode active material containing layer. The dried product was pressed by calender rolls such that the porosity of the resulting cathode became 28%, and then was punched out into a size of 83 mm×102 mm, so as to yield the cathode.

Thus obtained anode and cathode were partly extended like ribbons, so as to form connection terminals. Subsequently, a separator made of polyolefin punched out into a size of 84 mm×104 mm was disposed between each pair of the anode and cathode, eight layers of thus obtained pairs of anodes and cathodes were stacked, and both end faces were pressed under heat, so as to yield a laminate. Thus obtained laminate was dried for 1 hr at 60° C. in vacuum.

The nonaqueous electrolytic solution was prepared as follows. First, a mixture of propylene carbonate (hereinafter referred to as PC as the case may be), ethylene carbonate (hereinafter referred to as EC as the case may be), and diethyl carbonate (hereinafter referred to as DEC as the case may be) at a volume ratio of PC:EC:DEC=2:1:7 was employed as a nonaqueous solvent, and LiPF₆ was added thereto as a solute at a ratio of 1.5 mol dm⁻³. Further, 5 parts by mass of 1,3-propane sultone and 0.5 part by mass of vinylene carbonate were added as additives to 100 parts by mass of the solution in which the nonaqueous solvent and solute were mixed, whereby the nonaqueous electrolytic solution was obtained.

The laminate was put into a package made of an aluminum laminate film and held in a vacuum chamber in this state. The nonaqueous electrolytic solution obtained as above was injected into the package. After the laminate was impregnated with the nonaqueous electrolytic solution under reduced pressure, the package was sealed in vacuum, whereby a lithium-ion secondary battery (having a length of 115 mm, a width of 85 mm, and a thickness of 2.7 mm) was made. As the aluminum laminate pack film, a laminate in which an innermost layer made of a synthetic resin (a layer made of denatured polypropylene) in contact with the nonaqueous electrolytic solution, a metal layer made of an aluminum foil, and a layer made of nylon were successively laminated in this order was used. Two such composite package films were overlaid on each other, and their fringes were heat-sealed, whereby the package was made.

The moisture content in the anode active material containing layer in thus obtained lithium-ion secondary battery was determined by the following method.

A part of an anode active material containing layer in a moisture analyzing sample laminate made under the same condition and dried under the same condition (1 hr at 60° C. in vacuum) was collected as an analysis sample. The moisture content in the sample was measured by using the Karl Fischer method. Further, the mass of the sample was determined. Thus, the moisture content in 1 g of the material constituting the anode active material containing layer was determined and taken as the moisture content in the anode active material containing layer included in Example 1. The moisture content was 80 ppm.

Thus obtained lithium-ion secondary battery was subjected to an initial charging/discharging characteristic evaluation test, a charging/discharging cycle characteristic evaluation test, and a safety evaluation test.

### Example 2

A lithium-ion secondary battery was made as in Example 1 except that the laminate was dried for 12 hr at 60° C. in vacuum and that the moisture content in the anode active material containing layer was 45 ppm. Thus obtained lithium-ion secondary battery was subjected to the initial charging/discharging characteristic evaluation test, charging/discharging cycle characteristic evaluation test, and safety evaluation test.

### Example 3

A lithium-ion secondary battery was made as in Example 1 except that the laminate was dried for 6 hr at 60° C. in vacuum and that the moisture content in the anode active material containing layer was 50 ppm. Thus obtained lithium-ion secondary battery was subjected to the initial charging/discharging characteristic evaluation test, charging/discharging cycle characteristic evaluation test, and safety evaluation test.

### Example 4

A lithium-ion secondary battery was made as in Example 1 except that the laminate was dried for 3 hr at 25° C. in vacuum and that the moisture content in the anode active material containing layer was 100 ppm. Thus obtained lithium-ion secondary battery was subjected to the initial charging/discharging characteristic evaluation test, charging/discharging cycle characteristic evaluation test, and safety evaluation test.

### Comparative Example 1

A lithium-ion secondary battery was made as in Example 1 except that the laminate was dried for 48 hr at 60° C. in vacuum and that the moisture content in the anode active material containing layer was 35 ppm. Thus obtained lithium-ion secondary battery was subjected to the initial charging/discharging characteristic evaluation test, charging/discharging cycle characteristic evaluation test, and safety evaluation test.

### Comparative Example 2

A lithium-ion secondary battery was made as in Example 1 except that the dried laminate was left in a room-temperature atmosphere again for 24 hr and that the moisture content in the anode active material containing layer was 110 ppm. Thus obtained lithium-ion secondary battery was subjected to the initial charging/discharging characteristic evaluation test, charging/discharging cycle characteristic evaluation test, and safety evaluation test.

### Comparative Example 3

A lithium-ion secondary battery was made as in Example 1 except that the laminate was not dried and that the moisture content in the anode active material containing layer was 120 ppm. Thus obtained lithium-ion secondary battery was subjected to the initial charging/discharging characteristic evaluation test, charging/discharging cycle characteristic evaluation test, and safety evaluation test.

The initial charging/discharging characteristic evaluation test, charging/discharging cycle characteristic evaluation test, and safety evaluation test were as follows:

Initial Charging/Discharging Characteristic Evaluation Test

Each lithium-ion secondary battery was initially charged at 25° C. after being made, and discharged immediately thereafter. The initial charging/discharging characteristic was evaluated according to the ratio between the charging capacity and discharging capacity at that time. For charging, constant-current constant-voltage charging was performed at 0.2 C (500 mA), which was a current value of 0.2 times the rated capacity value, until the voltage became 4.2 V. For discharging, constant-current discharging was carried out at 0.2 C until the voltage became 2.5 V. Table 1 shows thus obtained results, in which batteries yielding a ratio of 85% or higher were considered to have a practically sufficient initial charging/discharging characteristic. The value of discharging capacity under the condition mentioned above was taken as the battery capacity.

Charging/Discharging Cycle Characteristic Evaluation Test

After being made, the battery was subjected to 100 cycles of charging and discharging at 25° C., and then its discharging capacity A2 was measured. The charging/discharging cycle characteristic was evaluated according to the ratio between the discharging capacity A1 after the initial charging and discharging and A2[100×(A2/A1)] [%]. For charging, constant-current constant-voltage charging was performed at 1 C (2500 mA), which was a current value of 1 times the rated capacity value, until the voltage became 4.2 V. For discharging, constant-current discharging was carried out at 1 C (2500 mA) until the voltage became 2.5 V. Table 1 shows thus obtained results, in which batteries yielding a ratio of 90% or higher were considered to have a practically sufficient charging/discharging cycle characteristic.

Safety Evaluation Test

Thus obtained lithium-ion secondary batteries of Examples 1 to 4 and Comparative Examples 1 to 3 were subjected to the 150° C. heating test specified by UL1642, so as to evaluate their safety. The 150° C. heating test specified by UL1642 was performed such that each battery (having completed the charging at 4.2 V) was put into a thermostat, and its temperature was raised at a rate of 5° C./min from room temperature to 150° C. and then held at 150° C. for 1 hr. Table 1 shows the results. Among the results of 150° C. heating test shown in Table 1, “O” indicates the result of evaluation that “the battery was neither exploded nor ignited during the test,” whereas “X” indicates the result of evaluation that “the battery was exploded or ignited during the test.”

TABLE 1

| | | | MOISTURE | | | | |
|---|---|---|---|---|---|---|---|
| | | | CONTENT IN | INITIAL | BATTERY | CHARGING/ | SAFETY |
| | ADDITIVE | | ANODE ACTIVE | CHARGING/ | CAPACITY | DISCHARGING | EVALUATION |
| | (PARTS | | MATERIAL | DISCHARGING | (0.2 C. | CYCLE | (150° C. |
| | BY MASS) | | CONTAINING | CHARACTERISTIC | CAPACITY) | CHARACTERISTIC | HEATING |
| | PS | VC | LAYER (ppm) | (%) | (mAh) | (%) | TEST RESULT) |
| EXAMPLE 1 | 5 | 0.5 | 80 | 87.5 | 2665 | 95.8 | ∘ |
| EXAMPLE 2 | 5 | 0.5 | 45 | 88.2 | 2653 | 96.0 | ∘ |
| EXAMPLE 3 | 5 | 0.5 | 50 | 88.0 | 2644 | 95.7 | ∘ |
| EXAMPLE 4 | 5 | 0.5 | 100 | 86.8 | 2620 | 93.2 | ∘ |
| COMPARATIVE | 5 | 0.5 | 35 | 87.8 | 2643 | 96.2 | x |
| EXAMPLE 1 | | | | | | | |
| COMPARATIVE | 5 | 0.5 | 110 | 84.9 | 2592 | 89.6 | ∘ |
| EXAMPLE 2 | | | | | | | |
| COMPARATIVE | 5 | 0.5 | 120 | 84.6 | 2562 | 89.7 | ∘ |
| EXAMPLE 3 | | | | | | | |

As can be seen from the results shown in Table 1, it was verified that the lithium-ion secondary batteries of Examples 1 to 4 exhibited excellent charging/discharging characteristics, excellent charging/discharging cycle characteristics, practically sufficient capacities, and sufficient safety.

The present invention can provide a lithium-ion secondary battery which has excellent initial charging/discharging characteristic and charging/discharging cycle characteristic, and can attain sufficient safety even when intended to yield a higher capacity (a capacity of 2000 mAh or higher, or a capacity of 2500 mAh or higher).

The lithium-ion secondary battery of the present invention is useful as a power supply for electronic devices, portable electronic devices in particular.

1. A lithium-ion secondary battery comprising:
an anode including a conductive anode active material containing layer containing an anode active material;
a cathode including a conductive cathode active material containing layer containing a cathode active material;
a nonaqueous electrolytic solution containing a lithium salt, propylene carbonate, and a linear carbonate; and
a case accommodating the anode, cathode, and nonaqueous electrolytic solution in a closed state;
wherein the nonaqueous electrolytic solution further contains an additive satisfying the condition represented by the following expression (1); and
wherein the moisture content in the anode active material containing layer is regulated so as to satisfy the condition represented by the following expression (2):
+0.9V≦(E2−E1)≦+2.5V (1)
40 ppm≦C1≦100 ppm (2)
where E1 is the standard electrode potential (V vs. SHE) of a redox pair Li/Li⁺, and E2 is the standard electrode potential (V vs. SHE) of a redox pair of the additive in expression (1); and C1 is the moisture content in 1 g of the material constituting the anode active material containing layer in expression (2).

2. A lithium-ion secondary battery according to claim 1, wherein at least the anode active material and a binder adapted to bind particles of the anode active material to each other are used as the material constituting the anode active material containing layer.

3. A lithium-ion secondary battery according to claim 2, wherein the anode active material and binder in the anode active material containing layer have respective contents A and B [mass %] satisfying the conditions represented by the following expressions (3) and (4):
70≦A≦97 (3)
3≦B≦10 (4)

4. A lithium-ion secondary battery according to claim 2, wherein a conductive auxiliary agent is further used as the material constituting the anode active material containing layer.

5. A lithium-ion secondary battery according to claim 4, wherein the conductive auxiliary agent in the anode active material containing layer has a content [mass %] satisfying the condition represented by the following expression (5):
0≦D≦25 (5)

6. A lithium-ion secondary battery according to claim 1, wherein the nonaqueous electrolytic solution further contains ethylene carbonate therein.

7. A lithium-ion secondary battery according to claim 6, wherein propylene carbonate, ethylene carbonate, and the linear carbonate have respective contents X, Y, and Z [vol %] simultaneously satisfying the conditions represented by the following expressions (6) to (9):
10≦X≦60 (6)
1≦Y≦20 (7)
30≦Z≦80 (8)
X+Y+Z=100 (9)

8. A lithium-ion secondary battery according to claim 1, wherein the linear carbonate is at least one species selected from the group consisting of diethyl carbonate, dimethyl carbonate, and ethylmethyl carbonate.

9. A lithium-ion secondary battery according to claim 1, wherein the additive is at least one species of compound selected from the group consisting of respective compounds represented by the following general formulas (I), (II), and (III): 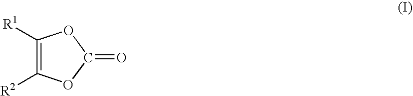
where R¹ and R² are either identical or different from each other and indicate any of hydrogen atom and hydrocarbon groups having a carbon number of 1 to 6; 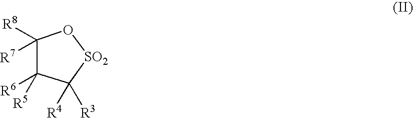
where R³, R⁴, R⁵, R⁶, R⁷, and R⁸ are either identical or different from each other and indicate any of hydrogen atom and hydrocarbon groups having a carbon number of 1 to 3; and 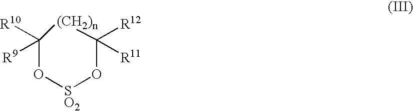
where R⁹, R¹⁰, R¹¹, and R¹² are either identical or different from each other and indicate any of hydrogen atom and hydrocarbon groups having a carbon number of 1 to 4, and n is 0 or 1.

10. A lithium-ion secondary battery according 15 to claim 9, wherein the compound represented by the general formula (I) is vinylene carbonate.

11. A lithium-ion secondary battery according to claim 9, wherein the compound represented by the general formula (II) is 1,3-propane sultone.

12. A lithium-ion secondary battery according to claim 9, wherein the compound represented by the general formula (III) is 1,3,2-dioxathiolane-2,2-dioxide.

13. A lithium-ion secondary battery according to claim 1, further comprising a porous separator disposed between the anode and the cathode;
wherein the separator is impregnated with the nonaqueous electrolytic solution.

14. A lithium-ion secondary battery according to claim 1, wherein the battery has a capacity of 2000 mAh to 5000 mAh.
